(19) United States
(12) Patent Application Publication
(10) Pub. No.: US 2007/0120813 A1
(43) Pub. Date: May 31, 2007

(54) Electronphoretic display unit and associated driving method

(75) Inventors: Hjalmar Edzer Ayco Huitema, Eindhoven (NL); Leendert Marinus Hage, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/573,744

(22) PCT Filed: Sep. 21, 2004
(86) PCT No.: PCT/IB04/51802

§ 371 Date: Mar. 28, 2006

(30) Foreign Application Priority Data
Oct. 1, 2003 (EP) 03103636.1

(51) Int. Cl. G09G 3/34

(52) U.S. Cl. 345/107

(57) ABSTRACT

Display units (1) comprise display panels (90) which are divided into active parts and inactive parts. The driving of an entire display panel (90) requires a minimum amount of time, which amount of time increases with an increasing number of rows and columns. By providing data signals to the pixels (11) located in active parts, and by supplying reference signals simultaneously to pixels (11) located outside the active parts, most of an amount of time available in a frame period is used for the active part, and, for a given frame period, the number of rows and columns of the display panel (90) can be increased. Respective parts are made active during respective 3 periods. A part may comprise a group of columns (ADG, BEH, CFI) and/or a group of rows (ABC, DEF, GHI). The display panel (90) may comprise multiplexing circuitry (50) and/or shift register circuitry (60) to reduce the number of connections between the display panel (90) and the rest of the display unit (1).

The invention relates to a display unit, to a display device comprising a display unit, to a method for driving a display unit, to a drive unit, and to a processor program product.

Examples of display devices of this type are: monitors, laptop computers, personal digital assistants (PDAs), mobile telephones and electronic books, electronic newspapers, and electronic magazines.

A prior art display unit is known from WO 99/53373, which discloses an electronic ink display comprising two substrates, with one of the substrates being transparent and having a common electrode (also known as counter electrode) and with the other substrate being provided with pixel electrodes arranged in rows and columns. A crossing between a row and a column electrode is associated with a pixel. The pixel is formed between a part of the common electrode and a pixel electrode. The pixel electrode is coupled to the drain of a transistor, of which the source is coupled to the column electrode or data electrode and of which the gate is coupled to the row electrode or selection electrode. This arrangement of pixels, transistors and row and column electrodes jointly forms an active matrix. A row driver (select driver) supplies a row driving signal or a selection signal for selecting a row of pixels and the column driver (data driver) supplies column driving signals or data signals to the selected row of pixels via the column electrodes and the transistors. The data signals corresponding to data to be displayed, and form, together with the selection signal, a (part of a) driving signal for driving one or more pixels.

Furthermore, an electronic ink is provided between the pixel electrode and the common electrode provided on the transparent substrate. The electronic ink comprises multiple microcapsules with a diameter of about 10 to 50 microns. Each microcapsule comprises positively charged white particles and negatively charged black particles suspended in a fluid. When a positive voltage is applied to the pixel electrode, the white particles move to the side of the microcapsule directed to the transparent substrate, and the pixel becomes visible to a viewer. Simultaneously, the black particles move to the pixel electrode at the opposite side of the microcapsule where they are hidden from the viewer. By applying a negative voltage to the pixel electrode, the black particles move to the common electrode at the side of the microcapsule directed to the transparent substrate, and the pixel appears dark to a viewer. Simultaneously, the white particles move to the pixel electrode at the opposite side of the microcapsule where they are hidden from the viewer. When the electric voltages are removed, the display unit remains in the acquired state and exhibits a bi-stable character.

To reduce the dependency of the optical response of the (electrophoretic) display unit on the history of the pixels, preset data signals are supplied before the data-dependent signals are supplied. These preset data signals comprise data pulses representing energies which are sufficient to release the (electrophoretic) particles from a static state at one of the two electrodes, but which are too low to allow the (electrophoretic) particles to reach the other one of the electrodes. Because of the reduced dependency on the history of the pixels, the optical response to identical data will be substantially equal, regardless of the history of the pixels. The underlying mechanism can be explained by the fact that, after the display device is switched to a predetermined state, for example a black state, the (electrophoretic) particles come to a static state. When a subsequent switching to the white state takes place, the momentum of the particles is low because their starting speed is close to zero. This results in a high dependency on the history of the pixels resulting in a long switching time to overcome this high dependency. The application of the preset data signals increases the momentum of the (electrophoretic) particles and thus reduces the dependency resulting in a shorter switching time.

The time-interval required for driving all pixels in all rows once (by driving each row one after the other and by driving all columns simultaneously once per row) is called a frame. Per frame, each data pulse for driving a pixel requires, per row, a row driving action for supplying the row driving signal (the selection signal) to the row for selecting (driving) this row, and a column driving action for supplying the data pulse, like for example a data pulse of the preset data signals or a data pulse of the data-dependent signals, to the pixel. The latter is done for all pixels in a row simultaneously.

When updating an image, firstly a number of data pulses of the preset data signals are supplied, further to be called preset data pulses. Each preset data pulse has a duration of one frame period. The first preset data pulse, for example, has a positive amplitude, the second one a negative amplitude, and the third one a positive amplitude etc. Such preset data pulses with alternating amplitudes do not change the gray value displayed by the pixel.

During one or more subsequent frames, the data-dependent signals are supplied, with a data-dependent signal having a duration of zero, one, two to for example fifteen frame periods. Thereby, a data-dependent signal having a duration of zero frame periods, for example, corresponds with the pixel displaying full black assuming that the pixel already displayed full black. In case the pixel displayed a certain gray value, this gray value remains unchanged when the pixel is driven with a data-dependent signal having a duration of zero frame periods, in other words when being driven with a driving data pulse having a zero amplitude. A data-dependent signal having, for example, a duration of fifteen frame periods comprises fifteen driving data pulses and results in the pixel displaying full white, and a data-dependent signal having a duration of one to fourteen frame periods, for example, comprises one to fourteen driving data pulses and results in the pixel displaying one of a limited number of gray values between full black and full white.

Each frame period requires the sequential selecting of each row and providing the data pulses for each pixel in a selected row. For a given frame period, the number of rows and columns that can be driven is limited, due to the amount of time required to perform the driving actions. These actions, for example, comprise the clocking of the data pulses into the data driver, the reading out of these data pulses, the supply of these data pulses to the pixels, the charging of the pixels with these data pulses, and the sequential selections of rows by the select driver. The amount of time required for the clocking actions increases with the number of columns, and the amount of time required for the selection actions increases with the number of rows, and therefore, for the given frame period, the number of rows/columns is limited.

The known display unit is disadvantageous, inter alia, as within a given frame period, a relatively small number of rows and columns can be driven.

It is an object of the invention, inter alia, to provide a display unit, which, within a given frame period, can drive a relatively large amount of rows and columns. The invention is defined by the independent claims. The dependent claims define advantageous embodiments.

A display unit according to the invention comprises
a display panel comprising bi-stable pixels; and
a drive unit for providing during a frame period data signals to pixels in an active part of the display panel and for providing reference signals to pixels in an inactive part of the display panel.

By dividing the display panel into an active part and one or more inactive parts, and by providing data signals to only those pixels located in the active part, most of an amount of time available in a frame period is used for the active part. A relatively small amount of the time available in a frame period is used for simultaneously supplying the reference signals to those pixels located outside the active part. As a result, the active part is now limited in the number of rows and columns by the given frame period, and the display panel as a whole can have a larger amount of rows and columns, without needing row or column drivers with an increased number of outputs. In case of the display panel being divided into two (three, four ect.) parts, the display panel can have about twice (thrice, four times etc.) as many rows and columns. Further, in case of a color display, one or more blocks may be red blocks, one or more blocks may be blue blocks, and one or more blocks may be green blocks. The invention may be applied to any type of display unit having bi-stable pixels, such as, for example, an electrophoretic display.

An embodiment of a display unit according to the invention is defined by, in a first frame, a first part being an active part and a second part being an inactive part, and, in a second frame, the second part being an active part and the first part being an inactive part. In this case, respective parts are made active during respective frame periods advantageously. This embodiment also comprises the situation that, in a number of first frames, a first part is an active part and a second part is an inactive part, and, in a number of second frames, the second part is an active part and the first part is an inactive part, etc.

An embodiment of a display unit according to the invention is defined by the reference signals having a voltage level situated between extreme voltage amplitudes of the data signals. The data signals for example have extreme voltage values of +15 Volt and −15 Volt, with the reference signals for example having a voltage level of 0 Volt or a few Volts equal to a voltage amplitude of the common electrode. Alternatively, the reference signals may have a voltage amplitude of a few Volts added to or subtracted from the voltage amplitude of the common electrode.

An embodiment of a display unit according to the invention is defined by a part comprising a group of columns. Because of the data pulses being clocked sequentially into the data driver per for example one, two or four columns simultaneously, this clocking requires a relatively large amount of time, which makes the dividing of the display panel into groups of columns advantageous. Further, this allows to drive more columns than the number of outputs of the data driver(s).

In case of four column blocks being used, the columns in the blocks could be distributed as follows. A first column is part of a first block, a second column is part of a second block, a third column is part of a third block, a fourth column is part of a fourth block, etc. The image update can then be as follows: first only the video signals of the first column block are transferred to the display panel. These video signals are transferred to all columns in all columns blocks. This means that the first, second, third and fourth column receive the video signals of the first column, a fifth, sixth, seventh and eighth column receive the video signals of the fifth column, etc. The result is that the complete display panel is refreshed, but only with the video signals of the first column block. Next, the video signals of the second column block are transferred to the display panel. These video signals are transferred to all columns in the second, third and fourth columns block. This means that the second, third and fourth column receive the video signals of the second column, the sixth, seventh and eighth recieve receive the video signals of the sixth column, etc. The result is that all pixels in the first and second column blocks have their correct switching state, while the pixels in the third and fourth column blocks have the same switching state as the pixels in the second column block. This can be repeated for the video signals of the third column block for the third and fourth column blocks and then finally the fourth column block is updated with its own video signals. Without this update method part of the old image is always present while the new image is addressed. Only when all four column blocks have been addressed the user can see the new information. With the method described above the user can see the image coarse grained first (only the information of the first column block is visible), while later the other information is added.

An embodiment of a display unit according to the invention is defined by the drive unit comprising data driving circuitry for supplying the data signals to the pixels and multiplexing circuitry for coupling the data driving circuitry via switching elements to the pixels in the active part of the display panel and for supplying reference signals via switching elements to the pixels in the inactive part of the display panel. The multiplexing circuitry like for example a multiplexer couples a first number of outputs of the data driving circuitry like for example a data driver to a second number of interconnections of the display panel. The second number of interconnections of the display panel comprises a first number of interconnections for receiving the data signals from the first number of outputs of the data driver, and all other interconnections receive the reference signals. This second number of interconnections is for example equal to the number of columns, which can now be much larger than the first number. As a result, the data driver no longer needs to have a number of outputs equal to the number of columns, but can be made smaller advantageously. Further, this is a simple way to use most of the amount of time available in a frame period for the active part, and to use a relatively small amount of the time available in a frame period for supplying the reference signals.

An embodiment of a display unit according to the invention is defined by the multiplexing circuitry being located on the display panel. This is for example done by integrating the multiplexing circuitry into the display panel (front or back side), which advantageously reduces the number of connections between the display panel and the data driver(s). This results in an increased reliability.

An embodiment of a display unit according to the invention is defined by a part comprising a group of rows. Because of the select driver selecting the rows sequentially, with the driving of each row requiring the sequential clocking of the data pulses into the data driver per for example one, two or four columns simultaneously, this driving of a single row requires a relatively large amount of time, which makes the dividing of the display panel into groups of rows advantageous.

In case of four row blocks being used, the rows in the blocks could be distributed as follows. A first row is part of a first block, a second row is part of a second block, a third row is part of a third block, a fourth row is part of a fourth block, etc. The image update can then be done as described before for the column blocks. Further, combinations of column blocks and row blocks are possible.

An embodiment of a display unit according to the invention is defined by the drive unit comprising selection driving circuitry for selecting switching elements coupled to the pixels, the selection driving circuitry comprising shift register circuitry for sequentially selecting groups of switching elements, wherein first groups of switching elements are located in the active part of the display panel and a second group of switching elements is located in the inactive part of the display panel. The selection driving circuitry like for example a select driver comprises shift register circuitry like for example a shift register to advantageously select sequentially first groups of switching elements situated in the active part of the display panel and to select subsequently the second group of switching elements situated in the inactive part of the display panel. Usually, the second group will be larger than each one of the first groups and may even be larger than the collection of first groups.

An embodiment of a display unit according to the invention is defined by the first groups of switching elements being rows in the active part of the display panel, and the second group of switching elements comprises all other rows of the display panel to be selected by the shift register circuitry simultaneously. By sequentially selecting a number of rows in the active part of the display panel for providing the data signals and subsequently selecting all other rows in the inactive part of the display panel for providing the reference signals, a simple embodiment has been created to use most of the amount of time available in a frame period for the active part, and to use a relatively small amount of the time available in a frame period for supplying the reference signals.

An embodiment of a display unit according to the invention is defined by the shift register circuitry being located on the display panel. This is for example done by integrating the shift register circuitry into the display panel (front or back side), which advantageously reduces the number of connections between the display panel and the rest of the display unit. This results in an increased reliability.

An embodiment of a display unit according to the invention is defined by the drive unit comprising selection driving circuitry, and multiplexing circuitry for coupling the selection driving circuitry to switching elements for sequentially selecting groups of switching elements, wherein first groups of switching elements are located in the active part of the display panel and a second group of switching elements is located in the inactive part of the display panel. The multiplexing circuitry like for example a multiplexer couples a first number of outputs of the selection driving circuitry like for example a row driver to a second number of interconnections of the display panel, etc. as described before.

An embodiment of a display unit according to the invention is defined by the multiplexing circuitry being located on the display panel. This is for example done by integrating the multiplexing circuitry into the display panel (front or back side), which advantageously reduces the number of connections between the display panel and the row driver(s). This results in an increased reliability.

An embodiment of a display unit according to the invention is defined by the drive unit comprising a controller which is adapted to provide shaking data pulses, one or more reset data pulses, and one or more driving data pulses to the pixels. The shaking data pulses for example correspond with the preset data pulses discussed before. The reset data pulses precede the driving data pulses to further improve the optical response of the display unit, by defining a fixed starting point (fixed black or fixed white) for the driving data pulse. Alternatively, the reset data pulses precede the driving data pulses to further improve the optical response of the display unit, by defining a flexible starting point (black or white, to be selected in dependence of and closest to the gray value to be defined by the following driving data pulses) for the driving data pulses.

The display device as claimed in claim 14 may be an electronic book, while the storage medium for storing information may be a memory stick, integrated circuit, a memory like an optical or magnetic disc or other storage device for storing, for example, the content of a book to be displayed on the display unit.

Embodiments of a method according to the invention and of a processor program product according to the invention correspond with the embodiments of a display unit according to the invention.

The invention is based upon an insight, inter alia, that the driving of an entire display panel requires a minimum amount of time, which amount of time increases with an increasing number of rows and columns of the display panel, and is based upon a basic idea, inter alia, that for a given frame period which is too short for driving the entire display panel, only an active part of the display panel is to be driven with data signals, while an inactive part can be driven with reference signals.

The invention solves the problem, inter alia, of providing a display unit, which, for a given frame period, can drive a relatively large number of rows and columns, and is advantageous, inter alia, in that for a given number of rows and columns, the frame period can be made shorter.

These and other aspects of the invention will be apparent from and elucidated with reference to the embodiments(s) described hereinafter.

In the drawings:

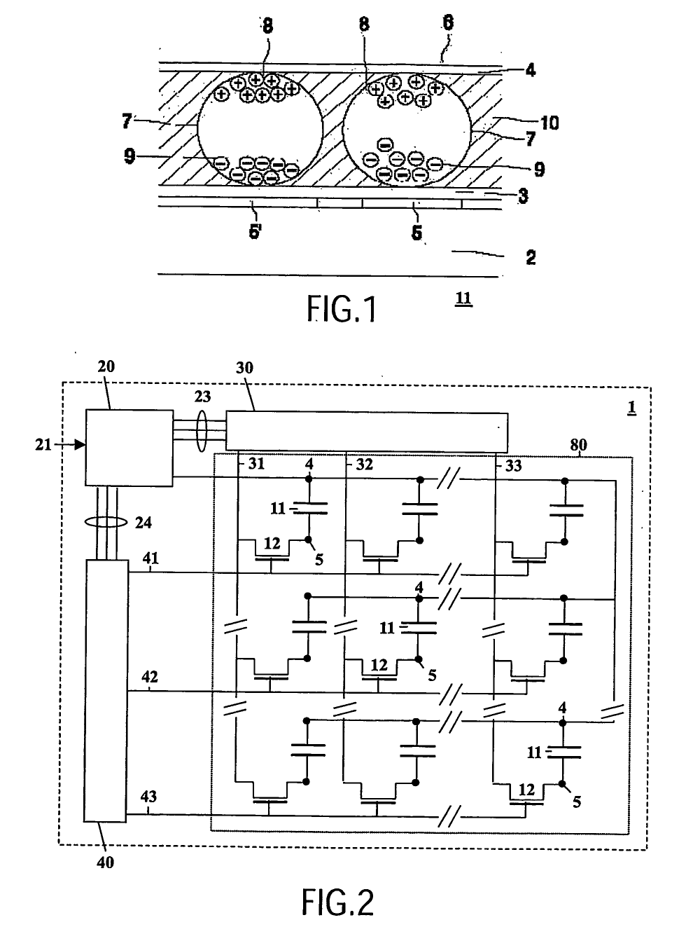

FIG. 1 shows (in cross-section) a bi-stable pixel;

FIG. 2 shows diagrammatically a display unit;

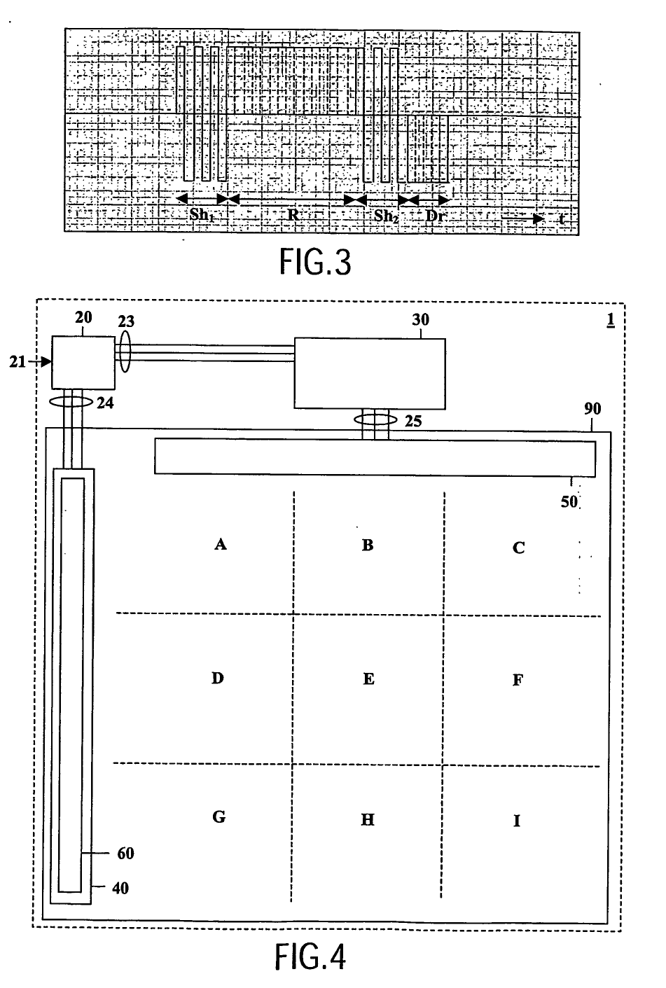

FIG. 3 shows a waveform for driving a display unit;

FIG. 4 shows diagrammatically a display unit according to the invention;

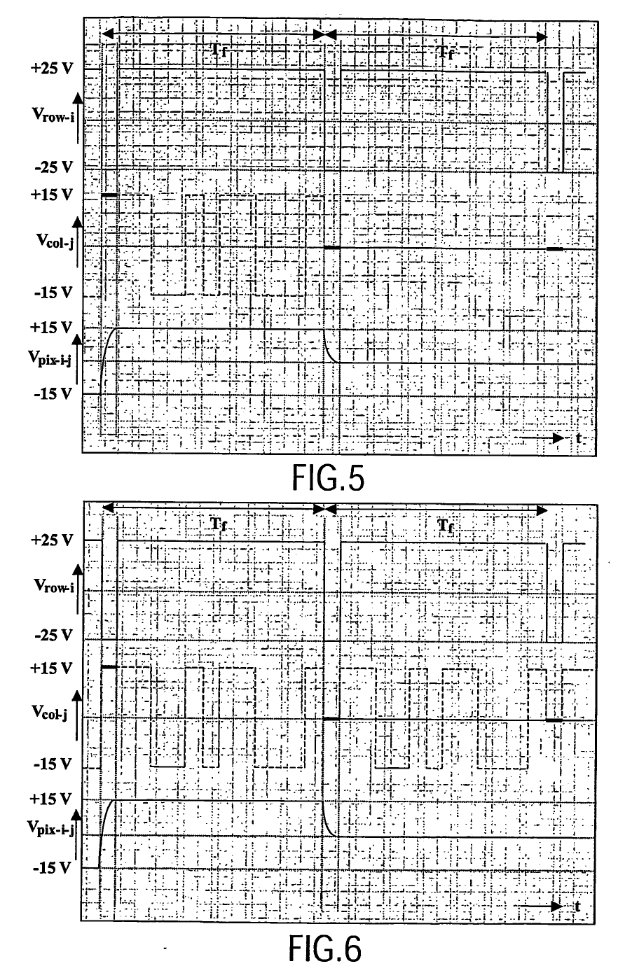

FIG. 5 shows waveforms for a group of columns being active and inactive; and

FIG. 6 shows waveforms for a group of rows being active and inactive.

The bi-stable pixel 11 of the display unit shown in FIG. 1 (in cross-section) comprises a bottom substrate 2 (like plastic or glass), an electrophoretic film (laminated on base substrate 2) with an electronic ink which is present between a transparent glue layer 3 and a transparent common electrode 4. The glue layer 3 is provided with transparent pixel electrodes 5. The electronic ink comprises multiple microcapsules 7 of about 10 to 50 microns in diameter. Each microcapsule 7 comprises positively charged white particles 8 and negatively charged black particles 9 suspended in a fluid 10. When a positive voltage is applied to the pixel electrode 5, the white particles 8 move to the side of the microcapsule 7 directed to the common electrode 4, and the pixel becomes visible to a viewer. Simultaneously, the black particles 9 move to the opposite side of the microcapsule 7 where they are hidden from the viewer. By applying a negative voltage to the pixel electrode 5, the black particles 9 move to the side of the microcapsule 7 directed to the common electrode 4, and the pixel appears dark to a viewer (not shown). When the electric voltage is removed, the particles 8, 9 remain in the acquired state and the display exhibits a bi-stable character and consumes substantially no power. In alternative systems, particles may move in an inplane direction, driven by electrodes which may be situated on the same substrate.

The (electrophoretic) display unit 1 shown in FIG. 2 comprises a display panel 80 comprising a matrix of pixels 11 at the area of crossings of line or row or selection electrodes 41, 42, 43 and column or data electrodes 31, 32, 33. These pixels 11 are all coupled. to a common electrode 4, and each pixel 11 is coupled to its own pixel electrode 5. The display unit 1 further comprises selection driving circuitry 40 (line or row or selection driver) coupled to the row electrodes 41, 42, 43 and data driving circuitry 30 (column or data driver) coupled to the column electrodes 31, 32, 33 and comprises per pixel 11 an active switching element 12. The display unit 1 is driven by these active switching elements 12 (in this example (thin-film) transistors). The selection driving circuitry 40 consecutively selects the row electrodes 41, 42, 43, while the data driving circuitry 30 provides data signals to the column electrode 31, 32, 33. Preferably, a controller 20 first processes incoming data arriving via input 21 and then generates the data signals. Mutual synchronisation between the data driving circuitry 30 and the selection driving circuitry 40 takes place via drive lines 23 and 24. Selection signals from the selection driving circuitry 40 select the pixel electrodes 5 via the transistors 12 of which the drain electrodes are electrically coupled to the pixel electrodes 5 and of which the gate electrodes are electrically coupled to the row electrodes 41, 42, 43 and of which the source electrodes are electrically coupled to the column electrodes 31, 32, 33. A data signal present at the column electrode 31, 32, 33 is simultaneously transferred to the pixel electrode 5 of the pixel 11 coupled to the drain electrode of the transistor 12. Instead of transistors, other switching elements can be used, such as diodes, MIMs, etc. The data signals and the selection signals together form (parts of) driving signals.

Incoming data, such as image information receivable via input 21 is processed by controller 20. Thereto, controller 20 detects an arrival of new image information about a new image and in response starts the processing of the image information received. This processing of image information may comprise the loading of the new image information, the comparing of previous images stored in a memory of controller 20 and the new image, the interaction with temperature sensors, the accessing of memories containing look-up tables of drive waveforms etc. Finally, controller 20 detects when this processing of the image information is ready.

Then, controller 20 generates the data signals to be supplied to data driving circuitry 30 via drive lines 23 and generates the selection signals to be supplied to row driver 40 via drive lines 24. These data signals comprise data-independent signals which are the same for all pixels 11 and data-dependent signals which may or may not vary per pixel 11. The data-independent signals comprise shaking data pulses forming the preset data pulses, with the data-dependent signals comprising one or more reset data pulses and one or more driving data pulses. These shaking data pulses comprise pulses representing energy which is sufficient to release the (electrophoretic) particles 8, 9 from a static state at one of the two electrodes 5, 6, but which is too low to allow the particles 8, 9 to reach the other one of the electrodes 5, 6. Because of the reduced dependency on the history, the optical response to identical data will be substantially equal, regardless of the history of the pixels 11. So, the shaking data pulses reduce the dependency of the optical response of the display unit on the history of the pixels 11. The reset data pulse precedes the driving data pulse to further improve the optical response, by defining a flexible starting point for the driving data pulse. This starting point may be a black or white level, to be selected in dependence on and closest to the gray value defined by the following driving data pulse. Alternatively, the reset data pulse may form part of the data-independent signals and may precede the driving data pulse to further improve the optical response of the display unit, by defining a fixed starting point for the driving data pulse. This starting point may be a fixed black or fixed white level.

In FIG. 3, a waveform representing voltages across a pixel 11 as a 8 of time t is shown for driving an (electrophoretic) display unit 1. This waveform is generated using the data signals supplied via the data driving circuitry 30. The waveform comprises first shaking data pulses Sh₁, followed by one or more reset data pulses R, second shaking data pulses Sh₂ and one or more driving data pulses Dr. For example sixteen different waveforms are stored in a memory, for example a look-up table memory, forming part of and/or coupled to the controller 20. In response to data received via input 21, controller 20 selects a waveform for a pixel 11, and supplies the corresponding selection signals and data signals via the corresponding driving circuitry 30, 40 and via the corresponding transistors 12 to the corresponding pixels 11.

A frame period corresponds with a time-interval used for driving all pixels 11 in the display unit 1 once (by driving each row one after the other and by driving all columns simultaneously once per row). For supplying data-dependent or data-independent signals to the pixels 11 during frames, the data driving circuitry 30 is controlled in such a way by the controller 20 that all pixels 11 in a row receive these data-dependent or data-independent signals simultaneously. This is done row by row, with the controller 20 controlling the selection driving circuitry 40 in such a way that the rows are selected one after the other (all transistors 12 in the selected row are brought into a conducting state).

During a first set of frames, the first and second shaking data pulses Sh₁, and Sh₂ are supplied to the pixels 11, with each shaking data pulse having a duration of one frame period. The starting shaking data pulse for example has a positive amplitude, the next one a negative amplitude, and the next one a positive amplitude etc. Therefore, these alternating shaking data pulses do not change the gray value displayed by the pixel 11, as long as the frame period is relatively short.

During a second set of frames comprising one or more frames periods, a combination of reset data pulses R is supplied, further to be discussed below. During a third set of frames comprising one or more frames periods, a combination of driving data pulses Dr is supplied, with the combination of driving data pulses Dr either having a duration of zero frame periods and in fact being a pulse having a zero amplitude or having a duration of one, two to for example fifteen frame periods. Thereby, a driving data pulse Dr having a duration of zero frame periods for example corresponds with the pixel 11 displaying full black (in case the pixel 11 already displayed full black; in case of displaying a certain gray value, this gray value remains unchanged when being driven with a driving data pulse having a duration of zero frame periods, in other words when being driven with a data pulse having a zero amplitude). The combination of driving data pulses Dr having a duration of fifteen frame periods comprises fifteen subsequent pulses and for example corresponds with the pixel 11 displaying full white, and the combination of driving data pulses Dr having a duration of one to fourteen frame periods comprises one to fourteen subsequent data pulses and for example corresponds with the pixel 11 displaying one of a limited number of gray values between full black and full white.

The reset data pulses R precede the driving data pulses Dr to further improve the optical response of the display unit 1, by defining a fixed starting point (fixed black or fixed white) for the driving data pulses Dr. Alternatively, reset data pulses R precede the driving data pulses Dr to further improve the optical response of the display unit, by defining a flexible starting point (black or white, to be selected in dependence of and closest to the gray value to be defined by the following driving data pulses) for the driving data pulses Dr.

Each frame period requires the sequential selecting of each row and providing the data pulses for each pixel in a selected row. For a given frame period, the number of rows and columns is limited, due to the amount of time required to perform the driving actions. These actions for example comprise the clocking of the data pulses into the data driving circuitry 30, the reading out of these data pulses, the supply of these data pulses to the pixels 11, the charging of the pixels 11 with these data pulses, and the sequential selections of rows by the selection driving circuitry 40. The amount of time required for the clocking actions increases with the number of columns, and the amount of time required for the selection actions increases with the number of rows, and therefore, for the given frame period, the number of rows/columns is limited. To increase the number of rows and columns of the. display unit 1 for a given frame period, according to the invention the display panel 80 is divided into parts comprising pieces, as shown in FIG. 4.

The display unit 1 according to the invention shown in FIG. 4 comprises the controller 20 coupled via the drive lines 23 to the data driving circuitry 30 and via the drive lines 24 to the selection driving circuitry 40 as already described for FIG. 2. In addition, the display panel 90 comprises multiplexing circuitry 50 coupled to the data driving circuitry 30 via lines 25. The selection driving circuitry 40 comprises shift register circuitry 60. The display panel 90 is divided into nine pieces A-I. Alternatively, the selection driving circuitry 40 comprising shift register circuitry 60 may be located outside the display panel 90.

By dividing the display panel 90 into an active part comprising for example one or three of the pieces A-I and one or more inactive parts comprising for example the others of the pieces A-I, and by providing data signals to only those pixels 11 located in the active part, most of an amount of time available in a frame period is used for the active part A relatively small amount of the time available in a frame period is used for simultaneously supplying reference signals to those pixels 11 located outside the active part. The data signals comprise information to be written into the pixels 11 in the active part. The reference signals are supplied to the pixels 11 in the inactive part to ensure that the information is retained which has been written into these pixels 11 before (at a moment in time at which these pixels 11 were still in the active part). As a result, the active part is now limited in number of rows and columns within a given frame period, and the display panel 90 as a whole can drive a larger number of rows and columns. In case of the display panel 90 being divided into two (three, four ect.) parts, the display panel 90 can have about twice (thrice, four times etc.) as many rows and columns.

Respective parts are made active during respective frame periods: In a first frame, a first part is an active part and a second part is an inactive part, and, in a second frame, the second part is an active part and the fist part is an inactive part. In this case, in each frame, the pixels 11 in the active part are driven with the data signals, and the other pixels 11 in the inactive part are driven with the reference signals. The reference signals have a voltage amplitude situated somewhere in the middle between extreme voltage amplitudes of the data signals. The data signals for example have extreme voltage values of +15 Volt and −15 Volt, with the reference signals for example having a voltage amplitude of 0 Volt or a few Volts equal to a voltage amplitude of the common electrode. Alternatively, the reference signals may have a voltage amplitude of a few Volts added to or subtracted from the voltage amplitude of the common electrode. The voltage amplitude of the reference signals must be such that the information written into the pixels before is not changed by the reference signals.

An active/inactive part may, for example, comprise a group of columns ADG, BEH, CFI. Because of the data pulses being clocked sequentially into the data driving circuitry 30 per, for example, one, two or four columns simultaneously, this clocking requires a relatively large amount of time, which makes the dividing of the display panel 90 into groups of columns ADG, BEH, CFI advantageous. The multiplexing circuitry 50 for coupling the data driving circuitry 30 to the switching elements 12 in the active part ADG of the display panel 90 during a particular frame period and for supplying reference signals to switching elements in the inactive part BEH+CFI of the display panel 90, like, for example, a multiplexer, couples a first number (for example one hundred) of outputs of the data driving circuitry 30 to a second number of interconnections (for example three hundred) of the display panel 90. The second number (three hundred) of interconnections of the display panel 90 comprises a first number (one hundred) of interconnections for receiving the data signals from the first number (one hundred) of outputs of the data driving circuitry 30, and all other interconnections (two hundred) receive the reference signals. This second number (three hundred) of interconnections is for example equal to the number of columns, which can now be much larger than the first number (one hundred). As a result, the data driving circuitry 30 no longer needs to have a number of outputs equal to the number of columns, but can be made smaller advantageously. By integrating the multiplexing circuitry 50 into the display panel 90, the number of connections between the display panel 90 and the rest of the display unit 1 is reduced.

An active/inactive part may for example comprise a group of rows ABC, DEF, GHI. Because of the selection driving circuitry 40 selecting the rows sequentially, with the driving of each row requiring the sequential clocking of the data pulses into the data driving circuitry per for example one, two or four columns simultaneously, the driving of a single row requires a relatively large amount of time, which makes the dividing of the display panel 90 into groups of rows ABC, DEF, GHI advantageous. The selection driving circuitry 40 comprises shift register circuitry 60 like for example a shift register to advantageously select sequentially first groups of switching elements 12 located in the active part ABC of the display panel 90 for supplying during a particular frame period the data signals to the-pixels 11 in this active part ABC and to select subsequently a second group of switching elements located in the inactive part DEF+GHI of the display panel 90 for supplying during the particular frame period the reference signals to the pixels in this inactive part DEF+GHI simultaneously. Usually, the second group will be larger than the first group. Each first group of switching elements 12 may be a row in the active part ABC of the display panel 90, with the second group of switching elements 12 comprising all other rows of the display panel 90 to be selected by the shift register circuitry 60 simultaneously. By integrating the shift register circuitry 60 into the display panel 90, the number of connections between the display panel 90 and the rest of the display unit 1 is reduced.

The waveforms shown in FIG. 5 for an active/inactive part comprising a group of columns ADG, BEH, CFI comprise voltages V_{row-i} (upper graph), V_{col-j} (middle graph) and Vₚᵢₓ₋ᵢ₋ⱼ (lower graph) as functions of time t. V_{row-i} represents the voltage supplied to the gates of the switching elements 12 in an i^{th} row via an i^{th} selection electrode. V_{col-j} represents the voltage supplied to the sources of the switching elements 12 in an j^{th} column via an j^{th} data electrode. Vₚᵢₓ₋ᵢ₋ⱼ represents the voltage across the pixel 11 at the crosspoint of the i^{th} row and the j^{th} column. In this example, the voltage at the common electrode 4 is at zero Volt. In a first frame period T_{f} starting with V_{row-1} being −25 Volt for the first time, a first group of columns comprising the jₜₕ column is active, and the other groups of columns are inactive. During V_{row-1} being −25 Volt in the first frame period, V_{col-j} is +15 Volt, and as a result, Vₚᵢₓ₋ᵢ₋ⱼ is about +15 Volt for the first frame substantially. As can be derived from FIG. 5, for a row 2, V_{col-j} is +15 Volt, for a row 3, V_{col-j} is +15 Volt, for a row 4, V_{col-j} is −15 Volt, etc. In frame period T_{f} starting with V_{row-1} being −25 Volt for the second time, a second group of columns is active, and the other groups of columns comprising the j^{th} column are inactive. While V_{row-1} is −25 Volt in the second frame period, V_{col-j} is 0 Volt, and as a result, Vₚᵢₓ₋ᵢ₋ⱼ becomes about 0 Volt and remains at this level for the second frame period.

So, in the first frame, row for row sequentially, the multiplexing circuitry 50 couples the data driving circuitry 30 simultaneously to the data electrodes in the active group of columns for simultaneously providing the data signals to the pixels 11 in this active group of columns, and, at the same time, the multiplexing circuitry 50 supplies the reference signals (for example all equal to 0 Volt) simultaneously to the data electrodes in the inactive group(s) of columns. Thereto, the multiplexing circuitry 50, for example, comprises a multiplexer having a first number of inputs coupled to the first number of inputs of the data driving circuitry 30 and a larger second number of outputs. During a respective frame, a first number of outputs of the multiplexing circuitry 50 is coupled to the first number of interconnections of the display panel 90 and all other outputs are coupled to a reference terminal.

The waveforms shown in FIG. 6 for an active/inactive part comprising a group of rows ABC, DEF, GHI comprise V_{row-i} (upper graph), V_{col-j} (middle graph) and Vₚᵢₓ₋ᵢ₋ⱼ (lower graph). V_{row-i} represents the voltage supplied to the gates of the switching elements 12 in an i^{th} row via an i^{th} selection electrode. V_{col-j} represents the voltage supplied to the sources of the switching elements 12 in an j^{th} column via an j^{th} data electrode. Vₚᵢₓ₋ᵢ₋ⱼ represents the voltage across the pixel 11 at the crosspoint of the i^{th} row and the j^{th} column. In this example the voltage at the common electrode 4 is again at zero Volt. In a first frame period T_{f} starting with V_{row-1} being −25 Volt for the first time, a first group of rows comprising the 1^{th} row is active, and the other groups of rows are inactive. During V_{row-1} being −25 Volt in the first frame period, V_{col-j} is +15 Volt, and as a result, Vₚᵢₓ₋ᵢ₋ⱼ is about +15 Volt for the first frame period substantially. As can be derived from FIG. 6, for a row 2, V_{col-j} is +15 Volt, for a row 3, V_{col-j} is +15 Volt, for a row 4, V_{col-j} is −15 Volt, etc., with rows 2, 3, 4 etc. all forming part of the first group of rows. In a second frame period T_{f} starting with V_{row-1} being −25 Volt for the second time, a second group of rows is active, and the other groups of rows comprising the 1^{th} row are inactive. While V_{row-i} is −25 Volt in the second frame period, V_{col-j} is 0 Volt, and as a result, Vₚᵢₓ₋ᵢ₋ⱼ becomes about 0 Volt and remains at this level during the second frame period.

So, in the first frame, in the active group of rows, row for row sequentially, the shift register circuitry 60 selects first groups of switching elements 12, with each first group of switching elements 12 forming part of one of the active rows, for simultaneously providing the data signals to the pixels 11 in this active row, and, in the inactive group(s) of rows, for all inactive rows simultaneously, the shift register circuitry 60 selects a second group of switching elements 12, which second group of switching elements 12 forms part of all these inactive rows, for simultaneously providing the reference signals (for example all equal to 0 Volt) to the pixels 11 in all these inactive rows. Thereto, the shift register circuitry 60 for example comprises a shift register for shifting a value from a first output of a first number (for example one hundred) of outputs to a last output of this first number (one hundred) of outputs and for sequentially shifting this value to all other outputs of a second number (for example two hundred) of outputs simultaneously (with the display panel 90 in this example comprising three hundred rows).

Controller 20 comprises and/or is coupled to a memory (not shown) like, for example, a look-up table memory for storing information about the waveforms and about the active/inactive parts of the display panel 90. The groups of active/inactive columns and the groups of active/inactive rows may be combined advantageously. A group of columns/rows may comprise neighbouring columns/rows and/or may comprise non-neighbouring columns/rows. The invention is not limited to electrophoretic display panels but can be used for any display panel based on bi-stable pixels. Generally, the (column) multiplexing circuitry 50 can be integrated into the data driving circuitry 30 (cost reduction), can be located between the data driving circuitry 30 and the display panel, and can be integrated on the front or the back of the display panel (reduced number of connections, more reliability). The shift register circuitry 60 can be integrated into the selection driving circuitry 40 (cost reduction), can be located between the selection driving circuitry 40 and the display panel, and can be integrated on the front or the back of the display panel (reduced number of connections, more reliability). Any possible (row) multiplexing circuitry can be integrated into the selection driving circuitry 40 (cost reduction), can be located between the selection driving circuitry 40 and the display panel, and can be integrated on the front or the back of the display panel (reduced number of connections, more reliability).

A drive unit 20, 30, 40, 50, 60 may comprise the above-mentioned circuitry, like the controller 20, the data driving circuitry 30, the selection driving circuitry 40, the multiplexing circuitry 50, and the shift register circuitry 60. The drive unit may be formed by one or more integrated circuits which may be combined with other components as an electronic unit. Alternatevely, the described functionality of the circuitry in the drive unit 20, 30, 40, 50, 60 may be distributed in a different way over the various mentioned circuitry or some of the functionality may be combined in a different way into one or more of the mentioned circuitry.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A display unit (1) comprising:
a display panel (90) comprising bi-stable pixels (11); and
a drive unit (20, 30, 40, 50, 60) for providing during a frame period data signals to pixels (11) in an active part of the display panel (90) and for providing reference signals to pixels (11) in an inactive part of the display panel (90).

2. A display unit (1) as claimed in claim 1, wherein, in a first frame, a first part is an active part and a second part is an inactive part, and, in a second frame, the second part is an active part and the first part is an inactive part.

3. A display unit (1) as claimed in claim 1, wherein the reference signals have a voltage level situated between extreme voltage amplitudes of the data signals.

4. A display unit (1) as claimed in claim 1, wherein a part comprises a group of columns.

5. A display unit (1) as claimed in claim 4, the drive unit (20, 30, 40, 50, 60) comprising
data driving circuitry (30) for supplying the data signals to the pixels (11); and
multiplexing circuitry (50) for coupling the data driving circuitry (30) via switching elements (12) to the pixels (11) in the active part of the display panel (90) and for supplying reference signals via switching elements (12) to the pixels (11) in the inactive part of the display panel (90).

6. A display unit (1) as claimed in claim 5, wherein the multiplexing circuitry (50) is located on the display panel (90).

7. A display unit (1) as claimed in claim 1, wherein a part comprises a group of rows.

8. A display unit (1) as claimed in claim 7, the drive unit (20, 30, 40, 50, 60) comprising selection driving circuitry (40) for selecting switching elements (12) coupled to the pixels (11),
the selection driving circuitry (40) comprising shift register circuitry (60) for sequentially selecting groups of switching elements (12), wherein first groups of switching elements (12) are located in the active part of the display panel (90) and a second group of switching elements (12) is located in the inactive part of the display panel (90).

9. A display unit (1) as claimed in claim 8, wherein the first groups of switching elements (12) are rows in the active part of the display panel (90); and the second group of switching elements (12) comprises all other rows of the display panel (90) to be selected by the shift register circuitry (60) simultaneously.

10. A display unit (1) as claimed in claim 8, wherein the shift register circuitry (60) is located on the display panel (90).

11. A display unit (1) as claimed in claim 7, the drive unit (20, 30, 40, 50, 60) comprising
selection driving circuitry (40); and
multiplexing circuitry for coupling the selection driving circuitry (40) to switching elements (12) for sequentially selecting groups of switching elements (12), wherein first groups of switching elements (12) are located in the active part of the display panel (90) and a second group of switching elements (12) is located in the inactive part of the display panel (90).

12. A display unit (1) as claimed in claim 11, wherein the multiplexing circuitry is located on the display panel (90).

13. A display unit (1) as claimed in claim 1, the drive unit (20, 30, 40, 50) comprising a controller (20) which is adapted to provide:
shaking data pulses (Sh₁,Sh₂);
one or more reset data pulses (R); and
one or more driving data pulses (Dr); to the pixels (11).

14. A display device comprising a display unit (1) as claimed in claim 1; and a storage medium for storing information to be displayed.

15. A method for driving a display unit (1) which comprises a display panel (90) comprising bi-stable pixels (11), which method comprises the step of:
providing during a frame period data signals to pixels (11) in an active part of the display panel (90) and providing reference signals to pixels (11) in an inactive part of the display panel (90).

16. A drive unit (20, 30, 40, 50, 60) connectable to a display panel (90) comprising bi-stable pixels (11), the drive unit (20, 30, 40, 50, 60) being adapted for providing during a frame period data signals to pixels (11) in an inactive part of the display panel (90).

17. A processor program product for providing data signals to a display panel (90) comprising bi-stable pixels (11), the processor program product comprising the function of: providing during a frame period data signals to pixels (11) in an inactive part of the display panel (90).
